(19) United States
(12) Patent Application Publication
(10) Pub. No.: US 2008/0074084 A1
(43) Pub. Date: Mar. 27, 2008

(54) ELECTRONIC DEVICE AND METHOD FOR CONTROLLING CHARGING CURRENT

(75) Inventors: HO IL LEE, Gwacheon city (KR); WILLAIM P. JR ALBERTH, Prairie, IL (US); MOONGYU CHOI, Seongnam City (KR); JONG SOO HWANG, Kyunggi-do (KR); YUN GON MOON, Seoul (KR); RICHARD NG, Palatine, IL (US)

Correspondence Address: MOTOROLA INC, 600 NORTH US HIGHWAY 45, W4 - 39Q, LIBERTYVILLE, IL, 60048-5343, US

(73) Assignee: MOTOROLA, INC., LIBERTYVILLE, IL (US)

(21) Appl. No.: 11/535,276

(22) Filed: Sep. 26, 2006

(51) Int. Cl. H02J 7/04

(52) U.S. Cl. 320/150

(57) ABSTRACT

The present invention provides an electronic device comprising a battery terminal (240) for coupling the electronic device (100) to a battery (280), a battery temperature terminal (242) for providing a battery temperature signal indicative of a temperature of the battery, a switch (210) selectively providing bi-directional coupling of a charging input (275) to the battery terminal (240), a power supply feed line ((B+)) coupling the charging input to at least one module (103, 102) of the electronic device (100), a diode (212, 220) providing continuous one way coupling from the battery terminal (240) to the power supply feed line ((B+)), a battery charging detector (235) having charging detect output (237), and a controller (230) having a control output (233) coupled to a control switch input (216) of the switch (210) and inputs coupled to both the battery temperature terminal (242) and the charging detect output (237), wherein in use the controller (230) open circuits the switch (210) in response to both receiving a charging signal from the battery charging detector indicating that the battery is being charged and receiving the battery temperature signal indicating that the battery temperature has exceeded a first predetermined threshold value.

### FIELD OF THE INVENTION

The present invention relates generally to the field of portable electronic devices powered by a re-chargeable battery.

### BACKGROUND OF THE INVENTION

Recharging a mobile phone re-chargeable battery typically requires a dedicated charging device or charger. This may provide a predetermined multi-pin or socket layout in order to connect with a corresponding interface on the mobile phone. In addition, the charging current from the charger will be controlled in some manner in order to avoid overcharging the battery or to limit charging at high temperatures. The specific parameters of the charger will depend on the mobile phone for which it is intended as well as any standards that the mobile phone or charger is designed to comply with.

The TTAS.KO-06.0028/R2 standard of the Telecommunications Technology Association of Korea (hereafter referred to as TTA) prescribes the operation of battery chargers for mobile phones sold and operated in South Korea. These TTA chargers include an ambient temperature sensor which is used to stop charging current being supplied to a connected mobile phone. However the actual battery temperature may be different from that of the temperature sensor in the charger which may result in charging the battery in a heated condition. This may cause damage to the battery, reduce its life, or even cause the battery to rupture exposing the mobile phone to damage and a mobile phone user to possible injury.

TTA chargers operate in one of three modes: a charging mode in which a current higher than an 100 mA current is drawn by the mobile phone from the charger; a charge complete and monitor mode in which current between 100 mA and 30 mA is drawn and the battery voltage is over 4.15V; and an error mode in which little or no current is drawn. In CDMA mobile phones in standby mode, an idle current is drawn in a periodic profile incorporating a sleep state in which typically less than 1 mA is drawn and a wake-up state when 100 mA is briefly drawn. When in use, for example taking a call or performing some other application, a mobile phone will typically draw far in excess of 100 mA from the charger (or battery if the charger is not connected). Similarly when the battery is being charged, more than the idle current will be drawn, and the charger will be in charging mode typically accompanied by illuminating a coloured LED. TTA chargers monitor the current drawn in order to determine a particular charging state or mode. In order to prevent the TTA charger entering an error mode, CDMA phones using TTA chargers are typically modified to execute an application when in standby in order to draw 100 mA instead of the normal idle current profile. When the TTA charger enters an error state, no charging current is supplied to the mobile phone until the charger is reset; typically by disconnecting and re-connecting the mobile phone. This situation may occur for example when an over-voltage protection switch operates to isolate the mobile phone from the charger. In this case, should the over voltage condition resolve, the charging or charged mode can then only be re-entered when the charger is reset. This may result in the battery being drained unnecessarily.

### BRIEF DESCRIPTION OF THE DRAWINGS

In order that the invention may be readily understood and put into practical effect, reference will now be made to an exemplary embodiment as illustrated with reference to the accompanying figures, where like reference numerals refer to identical or functionally similar elements throughout the separate views. The figures together with a detailed description below, are incorporated in and form part of the specification, and serve to further illustrate the embodiments and explain various principles and advantages, in accordance with the present invention where:

FIG. 1 is a schematic block diagram illustrating circuitry of a wireless device in accordance with an embodiment of the invention;

FIG. 2 is a schematic block diagram illustrating a power supply control circuit in accordance with an embodiment of the invention; and

FIG. 3 is a flow diagram illustrating a method of operating the power supply control circuitry of FIG. 2 in accordance with an embodiment of the invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION

Before describing in detail embodiments that are in accordance with the present invention, it should be observed that the embodiments reside primarily in combinations of method steps and device components related to battery charging. Accordingly, the device components and method steps have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

In this document, relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the method, or device that comprises the element.

In general terms in one aspect the present invention provides a method of controlling a charging current to a battery in an electronics device such as a mobile phone. The electronics device includes a switch selectively providing bi-directional coupling of a charging input to a battery terminal, the device also having a diode providing continuous one way coupling from the battery terminal to modules of the device. The method comprises opening the switch to an open circuit state in response to determining that both the temperature of the battery has exceeded a predetermined charge prevention threshold value and detecting a charging current is charging the battery. Power is provided from the battery to the modules of the device through the diode when the switch is in the open circuit state.

In an embodiment the battery temperature may be determined from a sensor in the battery package or in the battery housing. Suitably, closing of the switch to an open circuit state is in response to determining that the battery temperature has fallen below a predetermined charge allowed threshold value and/or in response to determining that the battery is not being charged. The predetermined charge allowed threshold value may be the same as or different from the predetermined charge prevention threshold value.

Suitably, a charging current is detected by determining a voltage polarity across the switch. This can be achieved by measuring the voltages on either side of the open circuited switch. If the battery side voltage is higher than the charging input side voltage, this indicates that no charging current is present.

There is also provided an electronic device comprising a battery terminal for coupling the electronic device to a battery, a battery temperature terminal for providing a battery temperature signal indicative of a temperature of the battery, a switch selectively providing bi-directional coupling of a charging input to the battery terminal, a power supply feed line coupling the charging input to at least one module of the electronic device, a diode providing continuous one way coupling from the battery terminal to the power supply feed line, a battery charging detector having charging detect output; and a controller having a control output coupled to a control switch input of the switch and inputs coupled to both the battery temperature terminal and the charging detect output, wherein in use the controller open circuits the switch in response to both receiving a charging signal from the battery charging detector indicating that the battery is being charged and receiving the battery temperature signal indicating that the battery temperature has exceeded a predetermined charge prevention threshold value.

In an embodiment, the battery temperature terminal may be coupled in use to a corresponding terminal within the battery package which includes a temperature sensor. Alternatively the temperature sensor may be integrated within the battery housing of the electronic device.

Suitably, the battery charging detector is implemented using an analogue-to-digital converter alternatively coupled to either side of the open switch, the voltage difference being provided as the charging detect output. This may be implemented within the controller or as a separate hardware and/or software module. In alternative embodiments, the battery charging detector may be implemented by receiving an external signal from the charger, by monitoring a mechanical operated by manual coupling or decoupling of the charger and electronic device, or by otherwise monitoring a voltage polarity across the switch, especially when open circuited.

The switch can be a FET and the diode is the FET's integral diode. Additionally or alternatively, the diode is an external diode coupled in parallel across the switch. In an embodiment, the controller close circuits the switch in response to the battery temperature signal indicates that the battery temperature is below a predetermined charge allowed threshold value. Alternatively or additionally, the controller close circuits the switch in response to not receiving a charging signal from the battery charging detector indicating that the battery is being charged.

The predetermined charge prevention threshold value suitably has the same value as the predetermined charge allowed threshold value. Alternatively the predetermined charge prevention threshold value and the predetermined charge allowed threshold value are different.

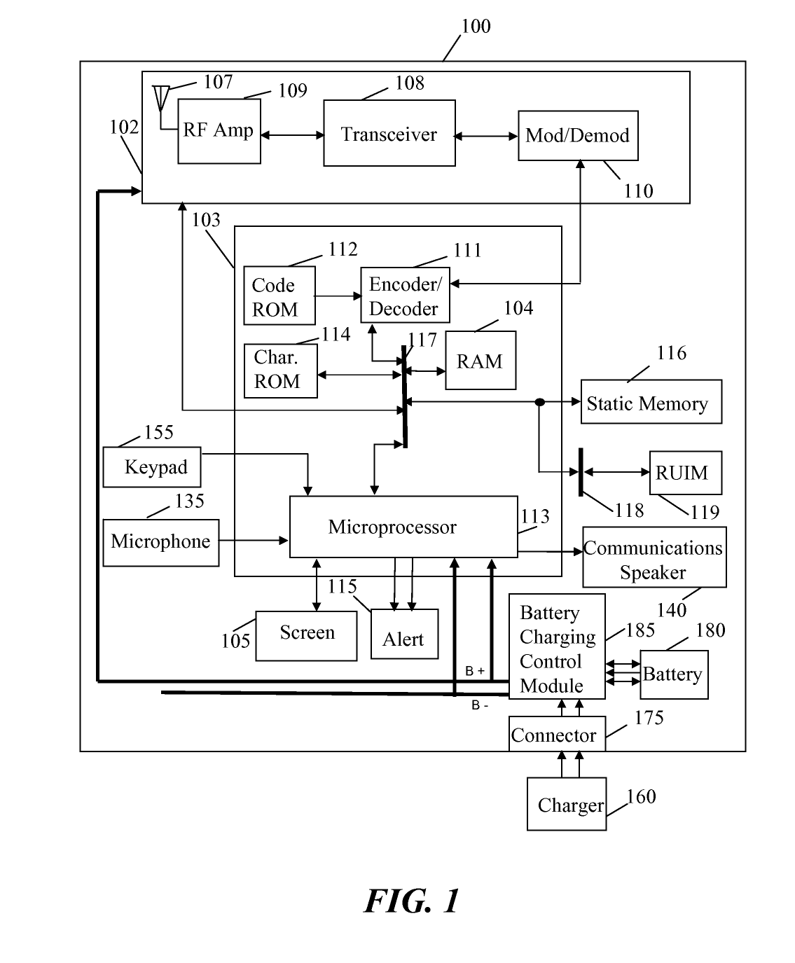

Referring to FIG. 1, there is a schematic diagram illustrating an electronic device 100, typically in the form of a mobile station or mobile telephone comprising a radio frequency communications unit 102 coupled to be in communication with a processor 103. The electronic device 100 also has a display screen 105. There is also an alert module 115 that typically contains an alert speaker, vibrator motor and associated drivers. The display screen 105, and alert module 115 are coupled to be in communication with the processor 103.

The processor 103 includes an encoder/decoder 111 with an associated code Read Only Memory (ROM) 112 for storing data for encoding and decoding voice or other signals that may be transmitted or received by the electronic device 100. The processor 103 also includes a micro-processor 113 coupled, by a common data and address bus 117, to the encoder/decoder 111, the radio frequency communications unit 102, a character Read Only Memory (ROM) 114, a Random Access Memory (RAM) 104, static programmable memory 116 and a Removable User Identity Module (RUIM) interface 118. The static programmable memory 116 and a RUIM card 119 (commonly referred to as a Subscriber Identity Module (SIM) card) operatively coupled to the RUIM interface 118 each can store, amongst other things, Preferred Roaming Lists (PRLs), subscriber authentication data, selected incoming text messages and a Telephone Number Database (TND phonebook) comprising a number field for telephone numbers and a name field for identifiers associated with one of the numbers in the name field. The RUIM card 119 and static programmable memory 116 may also store passwords for allowing accessibility to password-protected functions on the electronic device 100.

The micro-processor 113 has ports for coupling to the display screen 105, and the alert module 115. Also, micro-processor 113 has ports for coupling to a microphone 135 and a communications speaker 140 that are integral with the device.

The display screen 105 may be a touch screen and display soft or programmable keys for inputting commands and text to the electronic device 100. Alternatively or additionally the electronic device 100 may include dedicated or reconfigurable keys on a keypad 155.

The character Read Only Memory 114 stores code for decoding or encoding text messages that may be received by the communications unit 102. In this embodiment the character Read Only Memory 114, RUIM card 119, and static programmable memory 116 may also store Operating Code (OC) for the micro-processor 113 and code for performing functions associated with the electronic device 100.

The radio frequency communications unit 102 is shown for simplicity as a single operation unit, but it is envisaged the multiple radio frequency communications units 102 could possibly, but not necessarily, be included in the electronic device 100 in order to enable multiple communications modes for different cellular standards and two-way radio standards. The or each radio frequency communications unit 102 is a combined receiver and transmitter having a common antenna 107. The communications unit 102 has a transceiver 108 coupled to the antenna 107 via a radio frequency amplifier 109. The transceiver 108 is also coupled to a combined modulator/demodulator 110 that couples the communications unit 102 to the processor 103.

The electronics device 100 also includes a removable battery 180 and battery charging control module 185 for controlling charging current supplied to the battery 180 from an external charger 160 connected to a charging input connector 175. Power is supplied to the electronic device 100 from the battery 180 or from the battery charger 176 via the charging input connector 175. The battery 180 and the external charger 160 or charging input connector 175 are coupled to a power supply feed line (B+) and negative or ground feed line (B−) through the battery charging control module 185. The power supply feed line (B+) and negative or ground feed line (B−) are coupled either directly or through another power management module(not shown) to at least one module (103, 102) of the electronic device 100. Only some of these connections are illustrated for simplicity, however the skilled person will appreciate that typically all modules of an electronics device 100 that require a power will be supplied from the same power supply feed line (B+), even if this is used to provide other supply rails of different voltages.

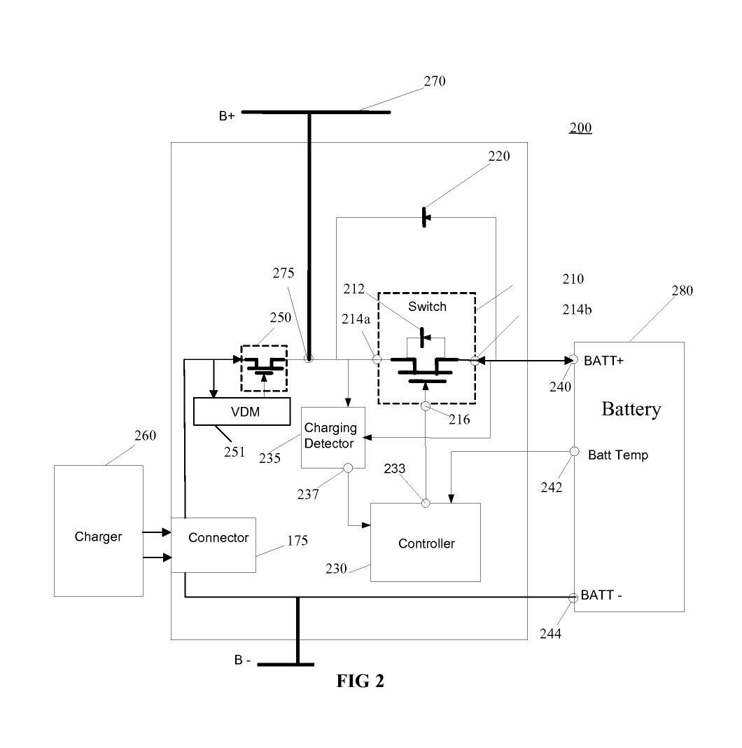

FIG. 2 shows the battery charging control module 185 of FIG. 1 in more detail. The battery charging control module 185 is coupled to the battery at a battery terminal 240 (BATT+) and battery terminal 244 (BATT−). The battery charging control 185 module is also coupled to a charging input or external connector 275 which connects with the external charger 160 (typically a TTA charger), however, it should be noted that the charger 160 can be any charger that provides a direct current charging current and could actually be integrated into the electronic device 100. As mentioned above, the battery charging control module 185 is also coupled to the power supply feed line (B+) for supplying power to modules (eg 103, 102) of the electronic device 100. The battery charging control module 185 comprises a charger isolation switch 210 which is typically implemented as a Field Effect Transistor (FET) having drain and source connections 214a and 214b to the main FET conduction channel as well as a gate or control switch input 216. However, it will be appreciated that any other form of switch can be sued such as a bi-polar transistor.

FET devices can also incorporate an integral diode 212 (or body diode) as is known and which is effectively coupled in parallel with the main FET conduction channel between the source 214b and drain 214a connections. The charger isolation switch 210 is connected such that the integral diode 212 blocks current from the power supply feed line (B+) and charging input 275 to the battery terminal 240, but allows current flow in the opposite direction through the switch 210 from the battery to the power supply feed line (B+). Thus the diode 212 provides continuous one way coupling from the battery terminal 240 to the power supply feed line (B+), irrespective of the state of the switch 210.

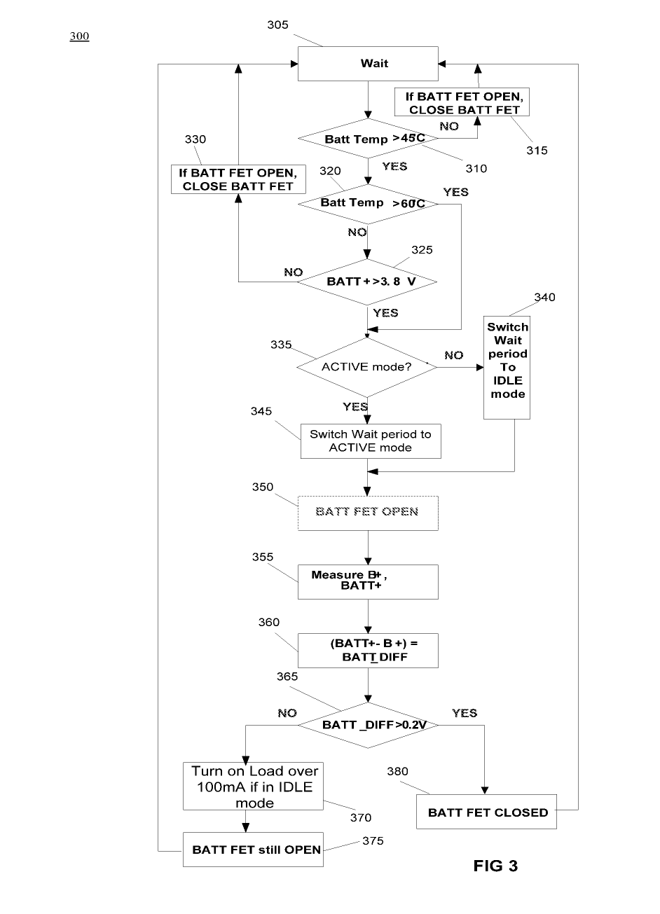

The switch 210 can be selectively open circuited such that no current flows through the main conduction channel (though some current may flow in the body diode 212), or close circuited in which current is allowed to flow freely in either direction through the main conduction channel. In the close circuited state, the switch 210 provides bi-directional coupling of the charging input 275 to the battery terminal 240. The switch 210 is selectively controlled by a controller 230 that as illustrated forms part of the battery charging control module 185, however, it is envisaged that the controller 230 could be formed as part of the processor 103 of the electronic device 100 operating according to control software which may be stored in the static programmable memory 116. This control software is described in more detail below with respect to FIG. 3.

The controller 230 has a control output 233 which is coupled to the control switch input 216 of the switch 210. The controller 230 receives a battery temperature signal from a battery temperature terminal 242 coupled to the battery temperature sensor (not shown) that is typically mounted in or adjacent to the battery 280. Thus, the battery 280 typically includes a package that houses the temperature sensor (not shown) which generates the battery temperature signal. As another option, the battery temperate sensor may be included as part of circuitry of the electronic device 100.

The controller 230 also receives a charging signal from the charging detect output 237 of a battery charging detector 235. The battery charging detector 235 is typically implemented as part of the processor 103 and control software, but may be implemented as a separate hardware and/or software module as is shown. In this embodiment the battery charging detector 235, has two inputs coupled to the switch 210 and is arranged to measure the voltage at the drain terminal 214a of the switch 210 and at the source terminal 214b of the switch 210 when the switch is open circuited. Thus the battery charging detector 235 measures the voltage (BATT+) on the battery side 214b and the voltage (B+) on the charging input side 214a of the open circuited switch 210. The difference (BATT_DIFF=BATT+−B+) between these two voltages reveals the voltage polarity across the switch 210. For example a negative polarity (BATT_DIFF<0V) where the battery voltage (BATT+) is lower than the charging input or power supply line voltage (B+) indicates that the charger is operating or supplying charging current. However when a positive voltage polarity (BATT_DIFF>0) is detected, where the battery voltage (BATT+) is higher than the power supply line voltage (B+) due to the voltage drop across the switch 210, this indicates that the battery 280 alone is supplying power to the power supply feed line (B+) and therefore the charger 260 is not connected to the charging input 275 or is not supplying charging current.

In practice, a slightly higher baseline voltage of 0.2V instead of 0V is used to determine the charging detect output. This is due to the voltage drop across the switch 210 when the charger 260 is disconnected and power is being supplied from the battery 280 through the switch 210 to the power supply feed line (B+). If the switch 210 is open circuited, current from the battery 280 to the power supply feed line (B+). will flow through the body diode 212 of the switch 210 which has a voltage drop of approximately 0.6-0.7V. In order to reduce this voltage drop, a parallel diode 220 is connected across the switch 210 in the same blocking configuration as the diode 212. This parallel diode 220 reduces the voltage drop across the switch 210 when the switch is open circuited to approximately 0.3V. This reduces power wastage when the electronic device 100 is being supplied by the battery 280, and ensures that an adequate voltage is provided to the power supply feed line (B+).

By determining that the voltage differential (BATT_DIFF) is greater than 0.2V, it can be assumed that the charger 260 is disconnected or otherwise not supplying a charging current to the battery 280. Otherwise it can be assumed that the charger is connected and supplying charging current to the battery.

The battery charging control module 185 may also include an over voltage protection (OVP) switch 250 or other protection measures. This OVP switch 250 opens when an over voltage condition is detected by a voltage detection module (VDM) 251 in order to isolate the electronic device 100 from the charger 160. In this situation, power will be supplied to the electronic device 100 from the battery 280.

The controller 230 is arranged to open circuit the switch 210 when the battery temperature exceeds a predetermined charge prevention threshold value as indicated by the battery temperature signal from the battery temperature terminal 242, and when the charging detect output 237 from the battery charging detector 235 indicates that the battery is being charged (BATT_DIFF>0.2). In this situation, power continues to be supplied to the power supply feed line (B+) from the charger via the charging input 275. However, open circuiting the switch 210 prevents charging current from reaching the battery 280 when it is hot. This prevents damage to the battery including reducing its useful life and power supply time. This isolation of the battery 280 from a charging current may also prevent rupture of the battery 280 which might otherwise lead to damage to the electronic device 100. Should the charger 260 be disconnected, then power to the power supply feed line (B+) is supplied from the battery through the body diode 212 of the open circuited switch 210 and the parallel diode 220.

The controller 230 may be arranged to close circuit the switch 210 when the battery temperature cools below a predetermined charge allow threshold value, which may be the same or different from the predetermined charge prevention threshold value used to trigger open circuiting of the switch 210. Alternatively the controller 230 may be arranged to close circuit the switch 210 when the battery charging detect output changes to indicate that the battery is no longer being charged by the charger 260. In a further alternative, the controller 230 may be arranged to require both of these conditions to hold before close circuiting the switch 210. These arrangements can be implemented in software executed by the controller. One example algorithm is described below.

FIG. 3 shows a flow diagram for a method (300) of operating the battery charging control module 185 and which will typically be implemented as software, hardware or firmware executed on the controller 230. At a step (305) the method (300) repeats periodically, following an initial wait period. This wait period may be configured depending on the state of the electronic device 100. For example a 15 second wait period may be used when the device is in an IDLE mode, that is the electronic device 100 is drawing the 1/100 mA sleep/wake-up current profile previously described when not actively in use. The wait period may be adjusted to 1 second when the device is being actively used for an application such as a phone call. The method (300) then, at a step (310), determines whether the temperature of the battery 180 has exceeded a predetermined charge allowed threshold value; in this embodiment the charge allowed threshold value has is 45 degrees Celsius. If this temperature threshold has not been exceeded (310N), then the method (300) closes the switch 210 if it is open, step (315), and returns to the wait step of step (305). If however the battery temperature has exceeded this predetermined charge allowed threshold value (310Y), the method (300) then at a step (320) determines whether the battery temperature has exceeded a predetermined charge prevention threshold value; in this embodiment the predetermined charge prevention threshold value is 60 degrees Celsius. If the battery temperature exceeds this second temperature threshold (320Y), then the method moves on to determine whether the electronic device 100 is in an active mode at step (340). If the battery temperature does not exceed this second threshold (320N), then the method (300) moves on to determine, at a step(325), whether the battery voltage (BATT+) at the battery terminal 240 exceeds a battery charging voltage threshold, typically 3.8V. In this embodiment, it is safe to charge the battery at high temperatures if the battery voltage is below the battery charging voltage (3.8V), however it is not safe to charge the battery at high temperatures (above 60 degrees Celsius in this example) when the battery voltage exceeds the battery charging voltage threshold (3.8V for CDMA mobile phone batteries).

If the battery does not exceed 3.8V (325N), then the method closes the switch 210 if it is open, step (330), and returns to the wait step (305). If however the battery voltage exceeds this battery charging voltage threshold (325Y), then the method (300) moves on to determine whether the electronic device 100 is in an active or high power mode at a step (335). This can be determined from another process resident on the electronic device 100, for example a CDMA mobile phone, as will be appreciated by those skilled in the art. Typically in an active mode, a CDMA mobile phone will draw in excess of 100 mA (335Y), and is indicative of the device executing a user application such as taking a phone call. In this case (335Y), the method switches the wait period of the wait step (305) to 1 seconds or another suitable active mode wait period at a step (345). If however the electronic device is in an idle or low power mode (335N), typically drawing less than 100 mA on average, the method switches the wait period to 15 seconds or another suitable idle mode wait period step (340).

Whether in ACTIVE or IDLE mode, the method (300) then moves on to determine whether the battery 180 is being charged. This is achieved in this embodiment by first opening the switch 210 at step (350). The voltage on the power supply feed line (B+) side (at terminal 214a) is measured by the method whilst the switch 210 is open, and the voltage on the battery 280 side (BATT+ at terminal 214b) is also measured whilst the switch is open at step (355). This will typically be implemented using an analogue-to-digital converter circuit (ADC) within the controller 230 or processor 103, which is first switched to the power supply line side 214a of the switch 210 where a reading is taken, and then the ADC is switched to the battery side terminal 214b of the switch and the voltage reading taken (355). This process would be appreciated and known by those skilled in the art. The method (300) then calculates the difference between the two voltage measurements: BATT+−B+=BATT_DIFF (360). A positive voltage difference value (BATT_DIFF) or voltage polarity across the switch 210 indicates that the battery voltage is higher than the voltage at the power supply feed line (B+) which in turn indicates that the charger is not coupled or is not providing charging current. However if the voltage difference value (BATT_DIFF) is negative, this indicates that the battery voltage (BATT+) is lower than the voltage (B+) at the power supply feed line (B+), which in turn indicates that the charger 160 is present and supplying the battery 280 with a charging current. In practice, a small voltage drop (0.2V) will exist across the body diode 212 of the switch 210 when open circuit and the parallel diode 220 (if used). Therefore the method (300) in this implementation determines whether the voltage difference (BATT_DIFF) is greater than 0.2V at step(365) in order to ensure that the charger is not connected. The skilled person will appreciate that a reference voltage other than 0.2V could be used, and this will typically depend on the particular implementation.

If the voltage difference (BATT+−B+=BATT_DIFF) is greater than 0.2V (365Y), effectively positive voltage polarity in this implementation, this indicates that the charger 260 is not charging the battery 280. The method (300) then closes the switch 210 at block (380). This further reduces the voltage drop across the switch 210 when the battery 280 is supplying the electronic device 100 with power. The method (300) then moves on to the initial waiting step (305).

If however the voltage difference (BATT+−B+=BATT_DIFF) is less than 0.2V (365Y), effectively a negative voltage polarity in this implementation, this indicates that the charger 260 is charging the battery 280 or is otherwise connected to the device. If the device is in IDLE mode where no applications are running and less than 100 mA is typically drawn, an application is started, block (370), to ensure that 100 mA is drawn from the TTA charger in order prevent the TTA charger entering an error mode. This step is specific to TTA chargers and will be appreciated and known by those skilled in the art. Whether or not step 375 is performed, the method (300) retains the switch 210 open (375). This prevents the charger 260 supplying charging current to the battery 280 whilst it is still in an elevated temperature condition. The method then moves on to the initial waiting step (305).

By utilising a battery temperature sensor within the electronic device 100 rather than the charger 260, and open circuiting the switch 210 when the battery temperate exceeds a threshold value and the charger is present and supplying charging current, the battery is protected from a dangerous charging condition. The embodiment also avoids putting a TTA type of charger 260 into error mode by locating the switch 210 on the battery side of the power supply line (B+) in order to ensure that current is always being drawn from the charger when it is connected. By closing the switch 210 when the charger 260 is removed or stops supplying the device 100, the voltage drop across the switch is reduced in order to minimise power consumption when the device is supplied from the battery 280.

In alternative embodiments, the method (300) may be modified to only close the switch 210 in response to the battery temperature falling below the threshold (60 degrees Celsius). Or the method may be arranged to only close the switch 210 in response to the charger 260 being disconnected from the device 100, or otherwise not detected.

In an alternative embodiment, the charger 160 may be detected using a dedicated pin connection with a non-TTA charger, or even a mechanical switch which is arranged to operate with insertion of the charger 160.

Whilst the embodiments have been described with respect to mobile phones, the invention can be implemented in any suitable electronics device 100 such as personal digital assistants (PDA) and personal media players, as well as devices not adapted for connection to any type of charger.

In the foregoing specification, specific embodiments of the present invention have been described. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims.

The skilled person will recognise that the above-described apparatus and methods may be embodied as processor control code, for example on a carrier medium such as a disk, CD- or DVD-ROM, programmed memory such as read only memory (Firmware), or on a data carrier such as an optical or electrical signal carrier. For many applications embodiments of the invention will be implemented on a DSP (Digital Signal Processor), ASIC (Application Specific Integrated Circuit) or FPGA (Field Programmable Gate Array). Thus the code may comprise conventional programme code or microcode or, for example code for setting up or controlling an ASIC or FPGA. The code may also comprise code for dynamically configuring re-configurable apparatus such as re-programmable logic gate arrays. Similarly the code may comprise code for a hardware description language such as Verilog™ or VHDL (Very high speed integrated circuit Hardware Description Language). As the skilled person will appreciate, the code may be distributed between a plurality of coupled components in communication with one another. Where appropriate, the embodiments may also be implemented using code running on a field-(re)programmable analogue array or similar device in order to configure analogue hardware.

We claim:

1. An electronic device comprising:
a battery terminal for coupling the electronic device to a battery;
a battery temperature terminal for providing a battery temperature signal indicative of a temperature of the battery;
a switch selectively providing bi-directional coupling of a charging input to the battery terminal, a power supply feed line coupling the charging input to at least one module of the electronic device;
a diode providing continuous one way coupling from the battery terminal to the power supply feed line;
a battery charging detector having a charging detect output; and
a controller having a control output coupled to a control switch input of the switch and inputs coupled to both the battery temperature terminal and the charging detect output, wherein in use the controller open circuits the switch in response to both receiving a charging signal from the charging detect output indicating that the battery is being charged and receiving the battery temperature signal indicating that the battery temperature has exceeded a predetermined charge prevention threshold value.

2. An electronic device as claimed in claim 1, wherein the controller close circuits the switch in response to the battery temperature signal indicates that the battery temperature is below a predetermined charge allowed threshold value.

3. An electronic device as claimed in claim 1, wherein the controller close circuits the switch in response to not receiving a charging signal from the battery charging detector indicating that the battery is being charged.

4. An electronic device as claimed in claim 1, wherein the charging signal is provided by determining a voltage polarity across the switch.

5. An electronic device as claimed in claim 4, wherein the battery charging detector has at least one input coupled to the switch

6. An electronic device as claimed in claim 1, wherein the diode is an integral diode integral with the switch.

7. An electronic device as claimed in claim 6 further comprising an external diode connected in parallel with the integral diode.

8. An electronic device as claimed in claim 2, wherein the first predetermined threshold value has the same value as the second predetermined threshold value.

9. An electronic device as claimed in claim 2, wherein the first predetermined threshold value and the second predetermined threshold value are different.

10. An electronic device as claimed in claim 1 having a battery charger coupled to the charging input and a battery coupled to the battery terminal.

11. A method for controlling a charging current to a battery in an electronics device having a switch selectively providing bi-directional coupling of a charging input to a battery terminal, the device also having a diode providing continuous one way coupling from the battery terminal to modules of the device, the method comprising:
opening the switch to an open circuit state in response to determining that both the temperature of the battery has exceeded a predetermined charge prevention threshold value and detecting a charging current is charging the battery; and
providing power from the battery to the modules of the device through the diode when the switch is in the open circuit state.

12. A method for controlling a charging current to a battery in an electronics device as claimed in claim 11, further comprising:
closing the switch to an open circuit state in response to determining that the battery temperature has fallen below a predetermined charge allowed threshold value.

13. A method for controlling a charging current to a battery in an electronics device as claimed in claim 11, further comprising:
closing the switch to an open circuit state in response to determining that the battery is not being charged.

14. A method of controlling a charging current as claimed in claim 11, wherein a charging current is detected by determining a voltage polarity across the switch.

15. A method of controlling a charging current as claimed in claim 12, wherein the first predetermined threshold value has the same value as the second predetermined threshold value.

16. A method of controlling a charging current as claimed in claim 12, wherein the first predetermined threshold value and the second predetermined threshold value are different.
